(19) United States
(12) Patent Application Publication
(10) Pub. No.: US 2023/0356940 A1
(43) Pub. Date: Nov. 9, 2023

(54) BODY ASSEMBLY FOR A REFUSE VEHICLE

(71) Applicant: Oshkosh Corporation, Oshkosh, WI (US)

(72) Inventors: Eric Codega, Oshkosh, WI (US); Jerrod Kappers, Oshkosh, WI (US); Jeff Meyer, Oshkosh, WI (US); Les Schwartz, Owatonna, MN (US); Umang Patel, Oshkosh, WI (US); Derek Wente, Oshkosh, WI (US); Brian Schad, Oshkosh, WI (US)

(21) Appl. No.: 18/312,152

(22) Filed: May 4, 2023

Related U.S. Application Data
(60) Provisional application No. 63/338,527, filed on May 5, 2022.

(51) Int. Cl. B65F 3/20

(52) U.S. Cl. CPC B65F 3/207; B65F 2003/006

(57) ABSTRACT

A refuse vehicle includes a chassis and a body supported by the chassis. The body defines a collection chamber that is configured to store refuse therein. The body includes a bottom wall and a sub-frame assembly. The sub-frame assembly includes a pair of frame rails and a plurality of cross-members. The pair of frame rails is coupled to the bottom wall and extending in a longitudinal direction along the bottom wall. The plurality of cross-members is engaged with the bottom wall and extend in a lateral direction that is substantially perpendicular to the longitudinal direction. Each of the plurality of cross-members extends through the pair of frame rails. The plurality of cross-members each has a uniform cross-sectional shape along their entire length.

### CROSS-REFERENCE TO RELATED PATENT APPLICATIONS

This application claims the benefit of and priority to U.S. Provisional Application No. 63/338,527, filed May 5, 2022, the entire contents of which is incorporated by reference herein.

### BACKGROUND

The present disclosure relates generally to the field of refuse vehicles and in particular the structure of the body and refuse container of the refuse vehicle.

### SUMMARY

On embodiment relates to a refuse vehicle that includes a chassis and a body supported by the chassis. The body defines a collection chamber that is configured to store refuse therein. The body includes a bottom wall and a sub-frame assembly. The sub-frame assembly includes a pair of frame rails and a plurality of cross-members. The pair of frame rails is coupled to the bottom wall and extending in a longitudinal direction along the bottom wall. The plurality of cross-members is engaged with the bottom wall and extend in a lateral direction that is substantially perpendicular to the longitudinal direction. Each of the plurality of cross-members extends through the pair of frame rails. The plurality of cross-members each has a uniform cross-sectional shape along their entire length.

Another embodiment relates to a refuse vehicle including a chassis, a body, and an arm lug assembly. The body is supported by the chassis and defines a collection chamber configured to store refuse therein. The arm lug assembly is configured to secure an actuator to the body. The arm lug assembly includes a first plate, a second plate, a cross-member, a first coupling member, and a second coupling member. The first plate includes a first lug portion and the second plate includes a second lug portion. The second plate is spaced laterally apart from the first plate. The cross-member extends through the first plate to the second plate. The first coupling member is coupled to the first plate and the cross-member and extends at a first angle away from the cross-member. The second coupling member is coupled to the cross-member opposite the first coupling member. The second coupling member is arranged symmetrically with the first coupling member.

Another embodiment relates to a refuse vehicle that includes a chassis, a body, and an arm lug assembly. The body is supported by the chassis and defines a collection chamber configured to store refuse therein. The body includes a bottom wall and a container sidewall extending along a lateral edge of the bottom wall. The arm lug assembly is configured to secure an actuator to the body. The container sidewall includes a plurality of vertical beams spaced apart along a longitudinal direction. The container sidewall further includes a support beam that extends at an angle between a longitudinal end of the container sidewall and the arm lug assembly.

Another embodiment relates to a refuse vehicle. The refuse vehicle includes a chassis, a body, at least one rail, a plurality of bars, and a tailgate. The body is supported by the chassis and defines a refuse container configured to store refuse therein. The refuse container comprises a bottom wall. The at least on rail is coupled to the bottom wall and extends in a longitudinal direction along the bottom wall. The plurality of bars are coupled to the bottom wall and extend from the at least one rail in a latitudinal direction. The plurality of bars are positioned along the longitudinal direction along the bottom wall. The tailgate is positioned at an end of the refuse container and is rotatably coupled to the body.

Another embodiment relates to a refuse vehicle. The refuse vehicle includes a chassis, a body, and an ejector mechanism. The body supports the chassis and defines the refuse container configured to store refuse therein. The refuse container comprises of a refuse container side wall. The ejector mechanism is positioned with the refuse container and includes at least one ejector track coupled to an inner portion of the refuse container side wall. The ejector mechanism also includes an ejector which is coupled to the ejector track. The ejector is selectively actuated along the ejector track to move from a refuse receiving position to a refuse ejecting position.

The present disclosure is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a refuse vehicle, according to an embodiment;

FIG. 2 is a perspective view of a bottom wall of a refuse container for use with a refuse vehicle, according to an embodiment;

FIG. 3 is a perspective view of a bottom wall of a refuse container for use with a refuse vehicle, according to another embodiment;

FIG. 4 is a perspective view of an arm lug assembly of a refuse container, according to an embodiment;

FIG. 5 is a perspective view of an arm lug assembly of a refuse container, according to another embodiment;

FIG. 6 is a perspective view of a refuse container side wall, according to an embodiment;

FIG. 7 is a perspective view of a refuse container side wall, according to another embodiment;

FIG. 8 is a perspective view of an ejector mechanism, according to an embodiment;

FIG. 9 is a perspective view of an ejector mechanism, according to another embodiment.

FIG. 10A is a is a perspective view of an arm lug assembly of a refuse vehicle, according to an embodiment; and

FIG. 10B is another perspective view of the arm lug assembly of FIG. 10A.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Refuse vehicles collect a wide variety of waste, trash, and other material from residences and businesses. Operators of the refuse vehicle transport the material from various waste receptacles within a municipality to a storage or processing facility (e.g., a landfill, an incineration facility, a recycling facility, etc.). The material from these waste receptacles is stored within the refuse container of the refuse vehicle. The refuse container includes a compactor to compact the material within the refuse container. As the refuse container receives material to compact, the material exerts a force on components within the refuse container which may lead to structural failure. To counter act these forces, structural members with complex shapes may be used which can increase cost and add complexity to manufacturing.

According to an exemplary embodiment, a refuse vehicle includes a refuse container having a sub-frame assembly that supports a bottom wall and at least one refuse container side wall. The sub-frame assembly includes a pair of chassis frame rails and a plurality of cross members (e.g., a plurality of frame members, a plurality of beams, a plurality of shafts, a plurality of support elements, a plurality of bars, etc.) coupled to the bottom wall. The cross-members have a uniform cross-sectional shape along their entire length. The cross-members may extend through the frame rails or may include identical sections arranged in diametrically opposed pairs on either side of the pair of chassis frame rails along the length of the refuse vehicle. The pairs of cross-members may be spaced in approximately equal intervals along the longitudinal direction to fully support the refuse container. The frame rails and the plurality of cross-members are configured to reduce weight of the refuse container and reduce complexity of manufacturing while maintaining adequate structural support to the refuse container.

In some embodiments, the refuse container includes an arm lug that is configured to pivotally couple portions of a lift arm assembly to the refuse container. The arm lug may include an arm lug support assembly that is coupled to the bottom wall of the refuse container and is configured to support the arm lug under load. The arm lug support assembly is designed to reduce the space claim along the bottom wall of the refuse container and can enable clearance for, and use of, a pusher axle (e.g., a fifth axle, etc.) that may be coupled to the chassis and the refuse container.

In some embodiments, the refuse vehicle also includes a refuse container sidewall that is designed to increase the strength of the refuse container under repeated operation of a packer within the refuse container that is used to compress refuse to increase the loading capacity of the refuse container. In some embodiments, the refuse container sidewall includes a plate and at least one support member (e.g., a cross-member, a hollow shaft, a bar, etc.) coupled to the outer portion of the refuse container side wall. The at least one support member extends between a first end of the refuse container and the arm lug and is angled with respect to the bottom wall so that the at least one support member is substantially aligned with packing forces caused by operation of the packer.

In some embodiments, the refuse vehicle may also include an ejector mechanism configured to selectively actuate an ejector along an ejector track to push garbage out of the refuse container. The ejector mechanism may include shoes that support the ejector track within the refuse container, a distance above the bottom wall of the refuse container so as to prevent ingestion of liquid refuse into the ejector track. The refuse vehicle as described herein may provide a variety of benefits including: (1) decreasing the risk of manufacturing issues and complexity, (2) reducing the need for alignment jigs and/or tooling necessary for manufacturing while improving throughput in the manufacturing process, (3) increasing structural reliability, (4) increasing the reliability of the ejector mechanism, and (5) optimizing space along the underbody to enable use of at least one pusher axle for improved load management and vehicle maneuverability.

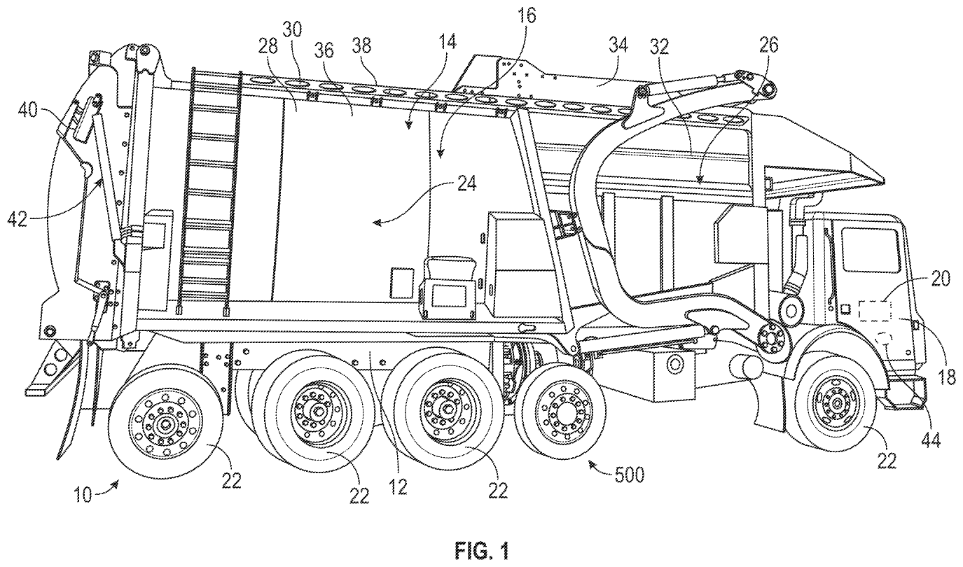

As shown in FIG. 1, a vehicle, shown as refuse vehicle 10 (e.g., garbage truck, waste collection truck, sanitation truck, etc.), includes a chassis, shown as a frame 12, and a body assembly, shown as body 14, coupled to the frame 12. The body 14 defines an on-board refuse container 16 and a cab 18. The cab 18 is coupled to a front end of the frame 12 and includes various components to facilitate operation of the refuse vehicle 10 by an operator (e.g., a seat, a steering wheel, hydraulic controls, etc.) as well as components that can execute commands automatically to control different subsystems within the vehicle (e.g., computers, controllers, processors, etc.). The refuse vehicle 10 further includes a prime mover 20 coupled to the frame 12 at a position beneath the cab 18. The prime mover 20 provides power to a plurality of motive members, shown as wheels 22, and to other systems of the vehicle (e.g., a pneumatic system, a hydraulic system, etc.). A pair of wheels may be coupled to an axle. The refuse vehicle 10 may include at least 2 axles. In some embodiments, the refuse vehicle 10 may include at least 4 axles, and may include 5 axles in various embodiments herein. The prime mover 20 may be configured to use a variety of fuels (e.g., gasoline, diesel, bio-diesel, ethanol, natural gas, etc.), according to various exemplary embodiments. According to an alternative embodiment, the prime mover 20 is one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1. For example, the refuse vehicle 10, may be in configurations such as a front loader, side loader, rear loader, or curb-sort recycling configuration.

According to an exemplary embodiment, the refuse vehicle 10 is configured to transport refuse from various waste refuse containers within a municipality to a storage or processing facility (e.g., a landfill, an incineration facility, a recycling facility, etc.). As shown in FIG. 1, the body 14 and on-board refuse container 16, in particular, includes a collection chamber 24 and a hopper 26. The collection chamber 24 is defined by a collection chamber first wall 28 (e.g., first wall, second wall, etc.), a collection chamber second wall (e.g., first wall, second wall, etc.), and a collection chamber top wall 30 (e.g., panel, cover, etc.). The hopper 26 is integrally formed with the collection chamber 24. As utilized herein, two or more elements are “integrally formed” with each other when the two or more elements are formed and joined together as part of a single manufacturing process to create a single-piece or unitary construction that cannot be disassembled without an at least partial destruction of the overall component. The hopper 26 is defined by a hopper first wall 32 (e.g., first wall, second wall, etc.), a hopper second wall (e.g., first wall, second wall, etc.), and a hopper top wall 34 (e.g., panel, cover, etc.). In some embodiments, the hopper first wall 32 is integrally formed with the collection chamber first wall 28 to form a first refuse container side wall shown as a first wall 36, the hopper second wall is integrally formed with the collection chamber second wall, so as to form a second wall (e.g., second refuse container side wall, etc.). The second wall is positioned opposite of the first wall 36 and is substantially parallel to the first wall. In some embodiment, the hopper top wall 34 is integrally formed with the collection chamber top wall 30 to form a refuse container top wall shown as top wall 38.

In some embodiments, the on-board refuse container 16 is shaped as a generally rectangular box having two transverse upper edges, two longitudinal upper edges, two transverse lower edges, and two longitudinal lower edges. The longitudinal edges extend along the length of the on-board refuse container 16 and the transverse edges extend across the length of the on-board refuse container 16, according to an exemplary embodiment.

The body 14 further includes a tailgate 40 which is movably (e.g., rotatably, etc.) coupled to the on-board refuse container 16. The tailgate 40 is positioned at the rear end of the body 14 and is configured to pivot about pivot pins positioned along the top surface of the on-board refuse container 16. Further, according to the embodiments shown in FIG. 1, the refuse vehicle includes a separate actuator and/or manual latch like assembly to secure the tailgate 40 to the refuse container 16 (e.g., rear body, refuse body, receptacle, etc.) of the refuse vehicle 10.

According to the embodiment shown in FIG. 1, the on-board refuse container 16, collection chamber 24 and the hopper 26 are each positioned behind the cab 18. In some embodiments, the collection chamber 24 includes a storage volume and the hopper 26 includes a hopper volume. Loose refuse is initially loaded into the hopper volume by a manual (e.g., by hand) or automatic means (e.g., lifting system) and is thereafter compacted into the storage volume. The collection chamber provides temporary storage for refuse during transport to a waste disposal site or a recycling facility. In some embodiments, at least a portion of the on-board refuse container 16 and collection chamber extend over or in front of the cab 18.

According to an exemplary embodiment, the hopper volume is positioned between the storage volume and the cab 18 (i.e., refuse is loaded into a position behind the cab 18 and stored in a position further toward the rear of the refuse vehicle 10). In other embodiments, the hopper volume is positioned at least partially within the tailgate 40 or proximate thereto.

As shown in FIG. 1, the refuse vehicle 10 includes a tailgate actuator assembly, shown as a tailgate actuator 42 (e.g., hydraulic actuator, linear actuator, piston, etc.). The tailgate actuator 42 is configured to move the tailgate 40 about the pivot pins between an open position (e.g., a first tailgate position, etc.) in which a lower end of the tailgate 40 is spaced apart from the refuse container 16 and a closed position (e.g., a second tailgate position, etc.) in which the tailgate 40 is rotated into engagement with the refuse container 16.

A first end (e.g., a first tailgate actuator end, etc.) of the tailgate actuator 42 is rotatably coupled to the tailgate 40. A second end (e.g., a second tailgate actuator end, etc.) of the tailgate actuator 42 is coupled to the refuse container 16. The tailgate actuator 42 is communicatively coupled to a processing unit shown as a processor 44. The processor 44 is configured to provide signals to selectively actuate the tailgate actuator 42. In some embodiments, the processor 44 monitors the position of the tailgate actuator 42 and the tailgate 40 (e.g., through communication with a position sensor within the tailgate actuator 42 and/or a position sensor within the tailgate 40). In some examples, the processor 44 communicates with a throttle and/or clutch of a vehicle transmission so that the tailgate actuator 42 cannot be deployed or otherwise adjusted outward from the fully-retracted position when the processor 44 receives an indication that the vehicle 10 is traveling over a threshold speed (e.g., 10 mph). In another example, the processor 44 may also receive signals from the sensors (e.g., proximity sensors, cameras, etc.) on the refuse vehicle 10 that indicate an unsafe condition for moving the on-board refuse container 16 towards the fully deployed position. In this example, the processor 44 may prevent adjustment of tailgate actuator 42 outward from the fully-retracted position. In yet other embodiments, the tailgate actuator 42 is controlled via a control level of a tailgate actuator 42 of the refuse vehicle 10.

In some embodiments, the tailgate actuator 42 can be controlled from within a central location, such as the cab 18 of the refuse vehicle 10. The cab 18 may include control panel including a series of inputs that can be actuated by a user to perform different operation. The control panel may also be in communication the processor 44 to provide signals and/or commands (e.g., command signals, etc.) that can be subsequently executed by the processor 44.

In some embodiments, the tailgate actuator 42 may include a hydraulic cylinder that is fluidly coupled to a hydraulic pump onboard the refuse vehicle 10. In other embodiments, the tailgate actuator 42 includes an electric actuator (e.g., linear actuator, etc.) and/or another actuator type. In operation, the actuator arm extends from the body 14 and out of the sleeve toward the tailgate 40 and causing the tailgate 40 to move upwardly and outwardly from the closed position to the open position. In the open position, the storage volume of the collection chamber 24 may be accessed such that the refuse may be removed.

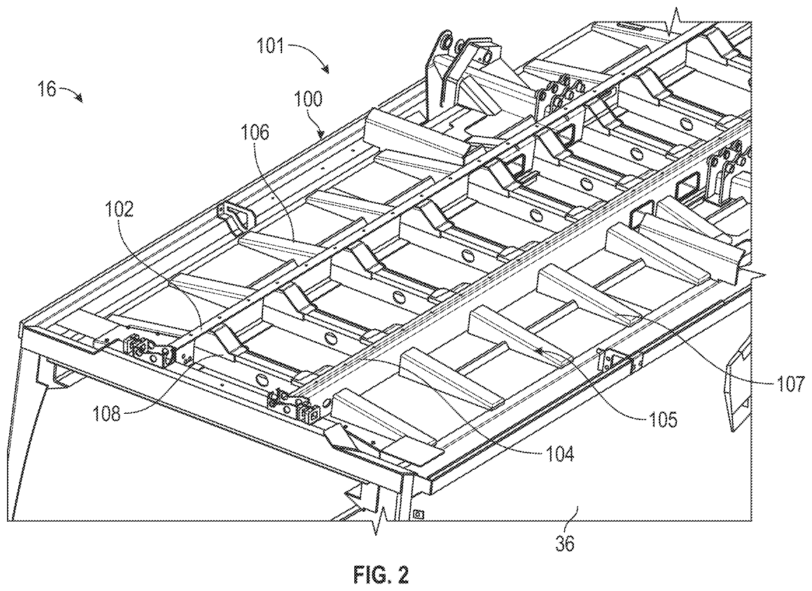

Referring to FIG. 2, a refuse container bottom base (e.g., a floor structure, etc.) of the refuse container 16 is shown as bottom wall 100, according to an embodiment. The bottom wall 100 (e.g., a base wall, a floor, etc.) is opposite the refuse container top wall and separates the collection chamber 24 (see FIG. 1) from the frame 12. The bottom wall 100 defines a lower inner surface of the refuse container 16 and is contiguous with the first wall 36 and the second wall.

The refuse container 16 includes a sub-frame assembly 101 that is configured to support the refuse container 16 above the axle(s) of the refuse vehicle. The sub-frame assembly 101 may form part of the vehicle frame 12 (see FIG. 1). The sub-frame assembly 101 includes a pair of frame rails, shown as a first rail 102 and a second rail 104, and a plurality of cross-members 105. The plurality of frame rails and cross-members 105 are coupled to the bottom wall 100 of the refuse container 16. The first rail 102 extends in a longitudinal direction along the bottom wall 100 between the cab and a rear end of the refuse vehicle. A length of the first rail 102 and the second rail 104 may be within a range between approximately 250 in. to 300 in. (e.g., 250 in., 260 in., 270 in., 280 in., 290 in., 292 in., 300 in., etc.) or another dimension. The second rail 104 is spaced laterally apart from first rail 102 and is oriented substantially parallel to the first rail 102.

The plurality of cross-members 105 (e.g., a plurality of frame members, a plurality of beams, a plurality of shafts, a plurality of support elements, a plurality of bars, etc.) are coupled to and extend across the bottom wall 100. The plurality of cross-members 105 includes a first cross-member 106 extending from the first rail 102 toward an outer lateral edge of the bottom wall 100, a second cross-member 108 extending between the first rail 102 and the second rail 104, and a third cross-member 107 extending from the second rail 104 toward a second outlet lateral edge of the bottom wall 100.

As shown in FIG. 2, the first cross-member 106 forms a wedge shape having a tapered lower surface. A thickness of the first cross-member decreases along a lateral direction moving away from the first rail 102. The third cross-member 107 is substantially similar to the first cross-member 106 and is disposed on an opposing lateral end of the bottom wall 100 as the first cross-member 106. The second cross-member 108 is a structural member that extends laterally between the first rail 102 and the second rail 104, and that is substantially aligned with the first cross-member 106 and the second cross-member 108 along the longitudinal direction. The first rail 102, the second rail 104 and the plurality of cross-members together provide structural support for the additional load of the refuse stored in storage volume.

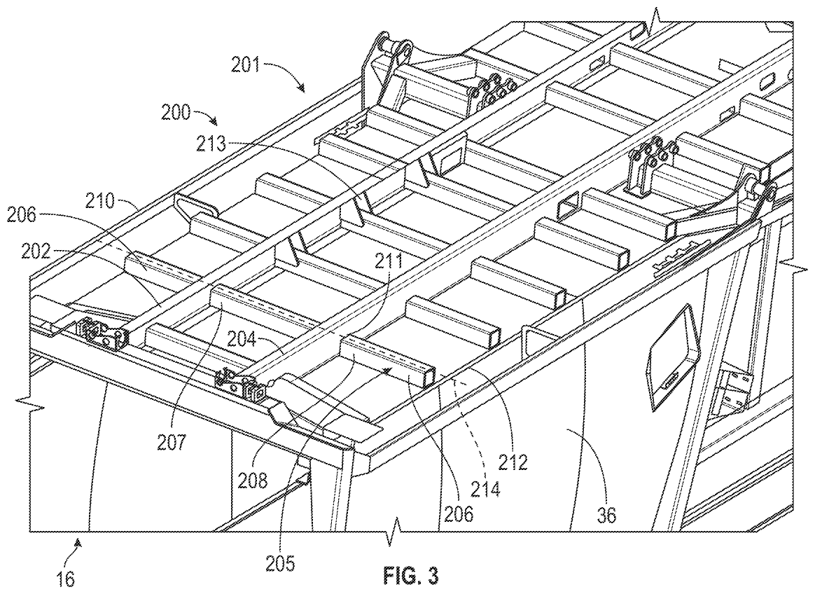

FIG. 3 shows another embodiment of a refuse container bottom base, shown as bottom wall 200, that can be used to support the refuse container 16. The bottom wall 200 can, beneficially, reduce the weight of the floor support structure of the refused contain 16, increase the strength of the refuse container 16, simplify manufacturing, and reduce jigs or tooling required during assembly of the bottom wall 200.

Similar to the sub-frame assembly 101 of FIG. 2, the sub-frame assembly 201 of FIG. 3 includes a pair of frame rails including a first rail 202 and a second rail 204. The second rail 204 is spaced laterally apart from and extends substantially parallel to the first rail 202. The first rail 202 and the second rail 204 are both coupled to the bottom wall 200. In some embodiments, the first rail 202 and/or the second rail 204 are integrally formed with the bottom wall 200. The first rail 202 and the second rail 204 extend in a longitudinal direction along the bottom wall 200 between the cab and a rear end of the refuse container 16.

In some embodiments, the first rail 202 and/or the second rail 204 are formed from a steel beam defining at least one C-shaped channel extending along the longitudinal direction. In the embodiment of FIG. 3, the first rail 202 and the second rail 204 define ‘C’ channels facing laterally toward one another and toward a longitudinal axis of the refuse vehicle. In other embodiments, the first rail 202 and/or second rail 204 may be made from another material (e.g., aluminum, etc.) and/or may have another cross-sectional shape (e.g., an T beam, a rectangular cross-section, a square cross-section, a circular cross-section, a rectangular beam forming a single ‘C’ channel, a ‘T’ shaped beam, or a ‘top-hat’ shaped frame member defining a channel facing away from the refuse container 16, etc.). The second rail 204 is substantially similar to the first rail 202 but may be different from the first rail 202 in other embodiments.

The sub-frame assembly 201 also includes a plurality of cross-members 205 (e.g., a plurality of frame members, a plurality of beams, a plurality of shafts, a plurality of support elements, a plurality of bars, etc.). The plurality of cross-members 205 are coupled to the bottom wall 200. In some embodiments, the cross-members 205 include multiple separate, yet identical sections at discrete longitudinal positions along the bottom wall 200. In at least one embodiment, the cross-members 205 are arranged in sets at a plurality of discrete longitudinal positions along the bottom wall 200.

In the embodiment of FIG. 3, each set of the plurality of cross-members 205 includes separate, yet identical sections arranged in a diametrically opposed pair on opposing sides of the pair of frame rails, and an inner cross-member section disposed between the pair of frame rails.

A first set of the plurality of cross-members 205 includes a first cross-member 206, a second cross-member 208, and a third cross-member 207. The first cross-member 206 is coupled to the bottom wall 200 and extends laterally from the first rail 202 to a first lateral edge 210 of the bottom wall 200. In some embodiments, the first cross-member 206, the second cross-member 208, and the third cross-member 207 are integrally formed with one another as a continuous piece that extends from the first lateral edge 210 through the first rail 202 and the second rail 204, and to the second edge 212. In such an embodiment, the cross-member 205 may extend through slots 211 (e.g., openings, holes, etc.) formed in the first rail 202 and the second rail 204 adjacent to the bottom wall 200. Such an arrangement can simplify positioning of the cross-member 205 during assembly and eliminate the need for jigs that align separate cross-member sections at each longitudinal position along the bottom wall 200. In other embodiments, the first cross-member 206, the second cross-member 208, and the third cross-member 207 are separate pieces that abut the frame rails.

In some embodiments, the first cross-member 206 extends from the first lateral edge 210 to the first rail 202, the second cross-member 208 extends from the first rail 202 to the second rail 204, and the third cross-member 207 extends from the second rail 204 to the second edge 212. The first cross-member 206, the second cross-member 208, and the third cross-member 207 are each centered on a horizontal axis 214 extending in the lateral direction normal to the frame rails from the first lateral edge 210 to the second edge 212. The first cross-member 206, the second cross-member 208, and the third cross-member 207 each have a uniform cross-section along their entire length in the lateral direction. In some embodiments, the dimensions (e.g., the length, the width, and the thickness) of the first cross-member 206 is substantially similar to, or has the same geometry as, the third cross-member 207, which reduces the number of components needed during the manufacturing operation. The first cross-member 206 may be formed from a metal material (e.g., steel, aluminum, etc.). In some embodiments, the first cross-member 206 may be hollow. In some embodiments, the first cross-member 206 may have a length within a range between approximately 84 inches (in.) to 108 in. (e.g., 84 in., 90 in., 96 in., 102 in., 108 in., etc.). The first cross-member 206 may have a width within a range between approximately 3 in to 6 in. (e.g., 3 in., 4 in., 5 in., 6 in., etc.). In some embodiments the first cross-member 206 may have a thickness within a range between approximately 3 in to 6 in. (e.g., 3 in., 4 in., 5 in., 6 in., etc.). In other embodiments, the dimensions of the first cross-member 206 may be different. In at least one embodiment, the first cross-member 206 is a steel tube (e.g., hollow tube) having a rectangular cross-sectional shape.

In some embodiments, the plurality of cross-member 205 are matched to one another (e.g., in shape, geometry, etc.) to enable self-locating of the cross-members 205 during manufacturing without requiring the use of jigs or other complex manufacturing equipment to place the cross-members 205 (e.g., the sub-frame assembly 201 is self-fixturing). In at least one embodiment, the second cross-member 208 is substantially similar to, or has the same geometry as, the first cross-member 206. The second cross-member 208 is coupled to the bottom wall 200 and is positioned at a first distance from the first cross-member 206. In some embodiments, the second cross-member 208 is formed to be identical to the first cross-member 206. According to at least one embodiment, the second cross-member 208 has the same length, width, and thickness as the first cross-member 206. In some embodiments, the sub-frame assembly 201 further includes brackets 213 (e.g., support plates, etc.) that are coupled to opposing longitudinal faces of the second cross-members 208. The brackets 213 may be disposed within channels defined by the first rail 202 and/or the second rail 204 to couple a respective one of the second cross-members 208 to the first rail 202 and/or the second rail 204. In some embodiments, a portion of the brackets 213 within the channel may have a height that is approximately equal to a height of the channel. In at least one embodiment, the brackets 213 may extend along the longitudinal face of a corresponding one of the cross-members 205 from the first rail 202 to the second rail 204 and may have a height that corresponds with a height of the cross-members 205 away from the frame rails.

The third cross-member 207 is substantially similar to, or has the same geometry as, the first cross-member 206 and second cross-member 208. The third cross-member 207 is coupled to the bottom wall 200 and is positioned at a second distance from second cross-member 208. The second distance between the third cross-member 207 and the second cross-member 208 is identical to the first distance between the first cross-member 206 and the second cross-member 208. In some embodiments, each of the plurality of cross-member 205 are positioned at an equal distance from one another.

The design and arrangement of the plurality of cross-members 205, the first rail 202, and the second rail 204, as described herein provide certain benefits such as decreasing manufacturing defects and build complexity. Specifically, using identical elements for each set of cross-members 205 at each longitudinal position can eliminate the need for specialized jigs and tooling which improve repeatability and speed of assembly. Such an arrangement can increase throughput during the manufacturing process. Further, the sub-frame assembly 201 described herein can also reduce the weight of the refuse container support structure while maintaining structural integrity.

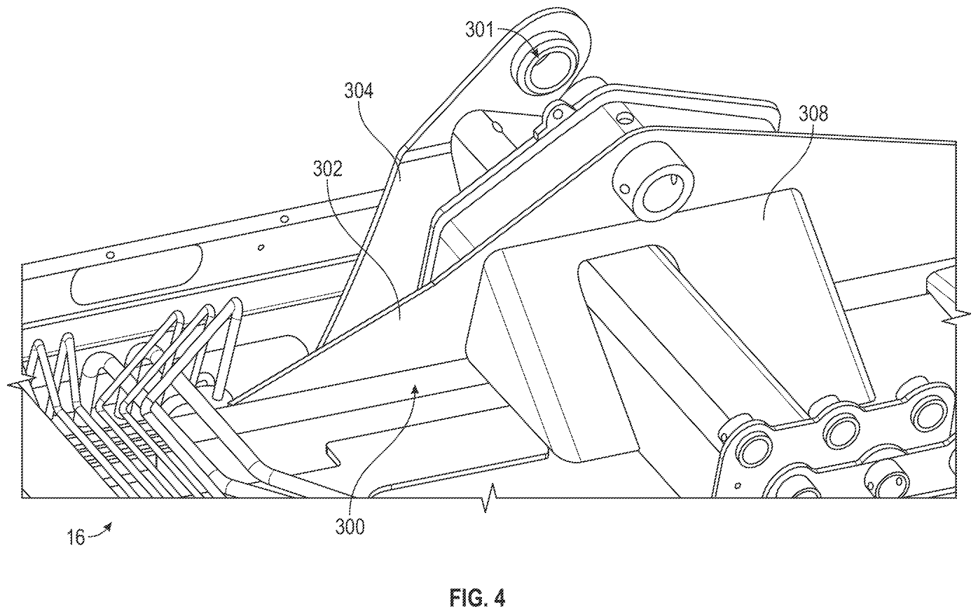

Referring to FIG. 4, an arm lug assembly 300 that may be used with or form part of the refuse container 16 (e.g., the sub-frame assembly 101, the sub-frame assembly 201) is shown, according to an embodiment. The arm lug assembly 300 is coupled to bottom wall 100 of the refuse container 16. In some embodiments, the arm lug assembly 300 includes an arm lug 301 that is configured to pivotally couple an actuator to the refuse container 16 (e.g., pneumatic cylinder, piston actuator, linear actuator, hydraulic cylinder, etc. that is used to power movement of a lift arm of the refuse vehicle relative to the refuse container 16). The arm lug assembly 300 includes a first plate 302 and a second plate 304. The first plate 302 is coupled to an outer lateral edge of the bottom wall 100. The second plate 304 is coupled to the first plate 302 by a beam 306 (e.g., an arm support member, etc.). The beam 306 is coupled to the bottom wall 100 and extends through the first plate 302 and is coupled to the second plate 304. The arm lug assembly 300 further includes an angled support member 308. The angled support member 308 is positioned around the beam 306 and is configured to stabilize the beam 306 under load.

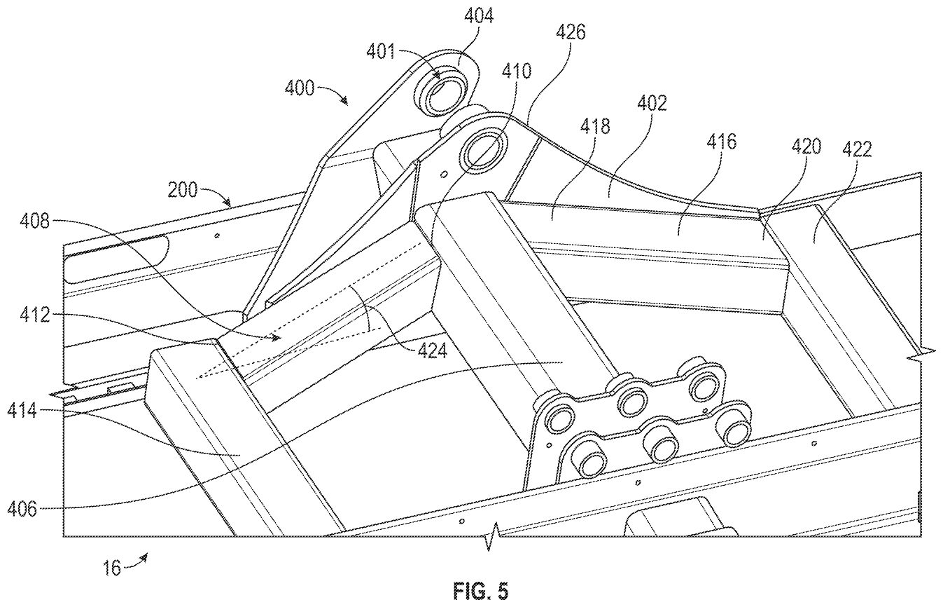

Referring to FIG. 5, another embodiment of an arm lug assembly 400 that may be used with or form part of the refuse container 16 (e.g., the sub-frame assembly 101, the sub-frame assembly 201) is shown. Among other benefits, the arm lug assembly 400 of FIG. 4 may, beneficially, increase the volume of space available along the bottom wall so as to provide clearance for another axle (e.g., fifth axle, pusher axle, etc.) to be coupled to the chassis. The arm lug assembly 400 includes a first plate 402, a second plate 404, a first beam, 406, a second beam 414, a third beam 422, a first coupling member 408, and a second coupling member 416. In other embodiments, the arm lug assembly 400 includes additional, fewer, and/or different components.

The first plate 402 is coupled to bottom wall 200 and includes a first lug portion of the arm lug 401. The arm lug assembly 400 includes a second plate 404 spaced laterally apart from the first plate 402 and oriented substantially parallel to the first plate 402. The second plate 404 includes a second lug portion of the arm lug 401. In at least one embodiment, the first lug portion and the second lug portion each define an opening configured to receive a pivot pin of the actuator therein. In at least one embodiment, a distal end (e.g., a lower end away from the refuse container, an axial end, etc.) of the first plate 402 and the second plate 404 define an arcuate edge 426 having a first convex portion, a second convex portion, and a concave portion extending from the first convex portion to the second convex portion.

The second plate 404 is coupled to the first plate 402 by a first beam 406. In some embodiments, the first beam 406 forms one of the plurality of cross-members 205 described in FIG. 3. In some embodiments, the first beam 406 is greater in length than the second beam 414 and the third beam 422. Specifically, the first beam 406 is extends through the first plate 402 and is coupled to the second plate 404. The arm lug assembly 400 is configured to receive a pin to pivotally couple an actuator the refuse container 16 and the frame 12. Specifically, the arm lug 401 is configured to receive an end of the actuator between the first plate 402 and the second plate 404. The actuator is configured to cause movement (e.g., linear movement, rotational movement, etc.) of at least one lift arm of the refuse vehicle about a pivot point.

The first coupling member 408 includes a first coupling member first end, shown as first end 410 (e.g., first end, second end, etc.) and a first coupling member second end, shown as second end 412 opposite the first end 410. The first coupling member 408 is coupled to the first beam 406 at the first end 410 and a second beam 414 at the second end 412. The first coupling member 408 extends between, and engages, the first beam 406 and the second beam 414. In some embodiments, the first coupling member 408 is angled relative to the first beam 406 and the second beam 414 so that the first end 410 is at a greater lateral position than the second end 412 (e.g., so that the first end 410 is farther away from a longitudinal axis of the refuse vehicle as compared to the second end 412). In some embodiments, the first coupling member 408 extends at an angle 424 within a range between approximately 25° to 85° (e.g., 25°, 30° 45°, 60°, 75°, 85°, etc.) relative to a longitudinal reference line passing through the second end 412. In other embodiments, the angle 424 may be different.

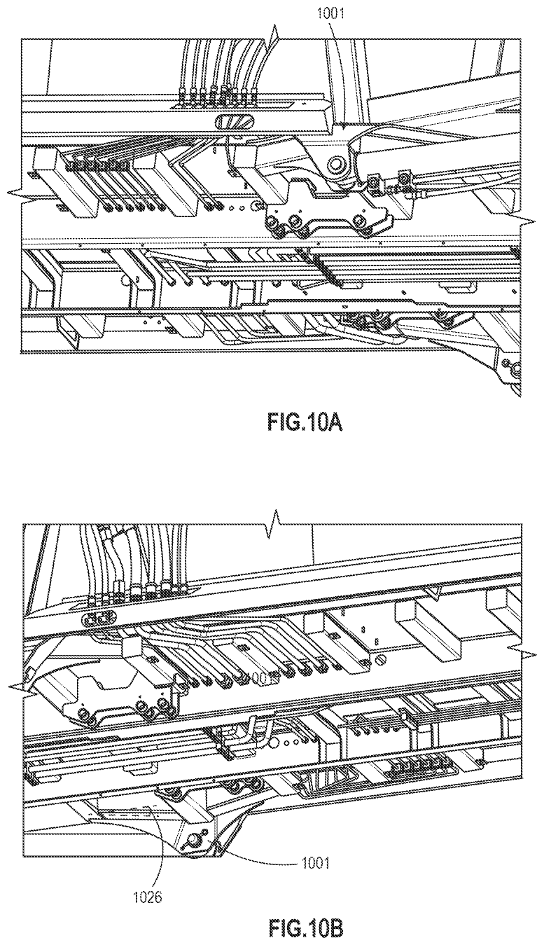

Referring to FIGS. 10A-10B, another embodiment of an arm lug assembly 1001 is shown. The arm lug assembly 1001 includes a first coupling member and a second coupling member. At least one of the first coupling member and the second coupling member extend at a first angle of inclination directed laterally away from a longitudinal axis (e.g., a centerline, etc.) of the refuse container and a second angle of inclination 1026 directed axially away from the bottom wall of the refuse container. The first angle of inclination may be the same as or similar to the first angle 424 described with reference to FIG. 4. In some embodiments, the first angle of inclination is approximately the same as the second angle of inclination. For example, the second angle of inclination may be within a range between approximately 25° to 85° (e.g., 25°, 30° 45°, 60°, 75°, 85°, etc.) relative to a longitudinal reference line passing through the second end of the cross-member. In other embodiments, the first and second angles of inclination are different.

Referring to FIG. 4, in some embodiments, the first coupling member 408 is also coupled to a first portion of the first plate 402 to provide structural support. The first coupling member 408 may be oriented substantially parallel to the first portion and may be welded or otherwise affixed to the first portion to increase the structural integrity of the first plate 402.

The second coupling member 416 is substantially similar to the first coupling member 408 and may have the same geometry as the first coupling member 408. The second coupling member 416 may be arranged symmetrically with the first coupling member 408. Together, the first coupling member 408 and the second coupling member 416 may define a ‘V’ shape when viewed from below the refuse container.

The second coupling member 416 includes a second coupling member first end 418 and a second coupling member second end 420 opposite from the second coupling member first end 418. The second coupling member first end 418 is coupled to the first beam 406 and the second coupling member second end 420 is coupled to a third beam 422. The second coupling member may also be coupled to a second portion of the first plate 402 to provide structural support to the first plate 402. The second portion of the first plate 402 may be on an opposite side of the arm lug 401 as the first portion.

In some embodiments, the third beam 422 is substantially similar to the second beam 414. Beneficially, the geometry and arrangement of the arm lug assembly 400 reduces the overall space claim along the bottom wall 200 and the side of the refuse container 16 such that additional components may be included on the frame 12 and/or refuse container 16.

Referring back to FIG. 1, in various embodiments, the refuse vehicle 10 includes an additional axle 500 (e.g., fifth axle, pusher axle, etc.). The additional axle 500 is coupled to the frame 12 and does not interfere with the bottom wall 200 due to the geometry and arrangement of the arm lug assembly 400. In some embodiments, the additional axle 500 is a fifth axle which is coupled to a pair of wheels 22. In some embodiments, the additional axle 500 is a pusher axle that is selectively repositionable between a retracted position in which the pusher axle is drawn against the frame and away from a ground surface and an extended position in which the pusher axle is lowered away from the frame to engage the wheels 22 with the ground surface. The additional axle 500 provides load distribution when refuse is stored in the storage volume and can provide greater maneuverability of the refuse vehicle 10 under certain operating conditions.

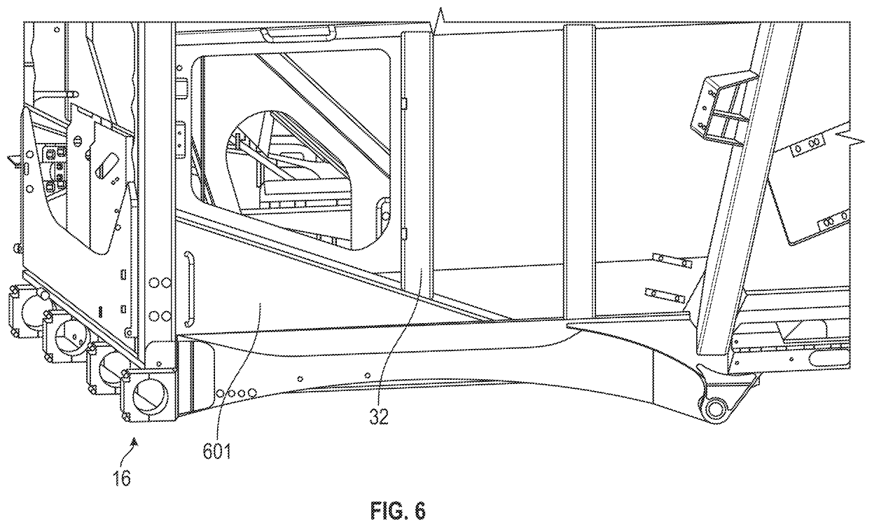

Referring to FIG. 6, a hopper portion of the refuse container 16 is shown, according to an embodiment. The refuse container 16 includes a structural triangular plate 601. The structural triangular plate 601 is coupled to the first container sidewall (the hopper first wall 32, etc.) of the refuse container and extends between a first end of the refuse container 16 and the arm lug assembly. In some embodiments, the structural triangular plate 601 is integrally formed with the first container sidewall.

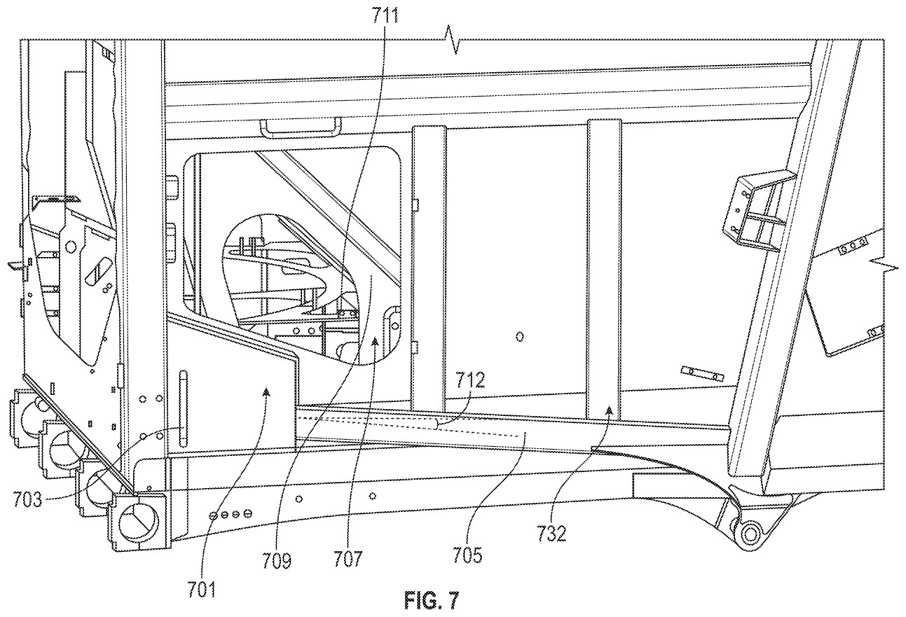

Referring to FIG. 7, a hopper portion (e.g., a forward portion, etc.) of another refuse container is shown that includes a first container sidewall 732 that is structured to increase the strength of the refuse container against repetitive loading from a packer actuator. The design of the first container sidewall 732 may, beneficially, reduce structural issues (e.g., cracks, deformation, etc.) which can occur over time due to repeated operation of the packer actuator. The first container sidewall 732 includes a support plate 701 (e.g., structural plate, flange, etc.) and a support beam 705 (e.g., a cross-member, a bar member, a support element, etc.). The support plate 701 is coupled to the first container sidewall 732 at an end of the first container sidewall 732 which may be, for example, proximate to the cab of the refuse vehicle. The support plate 701 may engage (e.g., abut, etc.) a substantially vertical support member (e.g., support beam, etc.) of the refuse container. In some embodiments, the support plate 701 has a trapezoidal shape, although the shape of the support plate 701 may be different in other embodiments. The support plate 701 includes a handle 703 that is configured to vehicle operations.

Each of the container sidewalls (e.g., the first wall 36 of FIG. 1, the second wall, etc.) includes a support beam structure that is configured to increase the strength of the refuse container against repeated operation of the packer. As shown in FIG. 7, the support beam 705 is coupled to the first container sidewall 732. In some embodiments, the support beam 705 is integrally formed with the first container sidewall 732. The support beam 705 is contiguous with the support plate 701 and extends from an edge of the support plate 701 along the first container sidewall 732. The support beam 705 extends from the support plate 701 along the first container sidewall 732 in a direction substantially parallel to the force applied by the packer 707 to refuse within the refuse container.

As shown in FIG. 7, the hopper 26 includes a packer 707 (e.g., a compacter, etc.). The packer 707 is positioned at least partially within the interior volume of the refuse container (e.g., the hopper volume, the storage volume, etc.) and is configured to compact loose refuse from the hopper volume into the storage volume. The packer 707 is connected to a packer actuator which moves the packer 707 within the interior volume. The packer 707 applies a force to the loose refuse compact the refuse within the storage volume. The refuse provides an opposing force on the packer 707 during operation. The packer 707 includes a packer plate that engages the loose refuse during operations. The packer plate may be formed of a metal (e.g., steel, aluminum, etc.). The packer plate is coupled to a plurality of support flanges 709 (e.g., support arms, etc.). The support flanges 709 in turn are coupled to the packer actuator and cause the packer plate to move and compact the loose refuse in the storage volume. The packer 707 includes a plurality of packer cross-members 711. The plurality of packer cross-members 711 are coupled to a side of the packer plate opposite of the refuse-facing side of the packer plate. The packer cross-members 711 extend across the side of the packer plate and are aligned with the force applied to the packer plate by the loose refuse when the packer 707 is operated.

Beneficially, the arrangement of the cross-members increases the structural reliability of refuse container when the packer 707 is actuated. Further, the load bearing of the packer plate and the packer flanges is optimized. In some embodiments, the packer cross-members 711 provide structural support and allow for the forces on the packer 707 to be distributed across the packer 707.

Further, as the loose refuse acts on the packer 707, force is transferred to the refuse container sidewalls. A first portion of the force is transferred along a longitudinal direction to the refuse container sidewalls. A second portion of the force acts along a vertical direction. The support beam 705 is substantially aligned with a force vector resulting from the longitudinal and vertical forces to resist the applied force from the packer. The support beam 705 is oriented at a beam angle 712 relative to a longitudinal reference line extending through the refuse container. In some embodiments, the support beam 705 is coupled to a distal end of a plurality of vertical beams that abut and support the first container sidewall 732. As shown in FIG. 7, the support beam 705 is coupled to, and may form part of, the arm lug assembly 400. In at least one embodiment, a first plate of the arm lug assembly 400 (e.g., the first plate 402 of FIG. 4) is engaged with and coupled to the support beam 705 along a proximal (e.g., an upper) edge of the first plate. Such an arrangement can reduce the risk of fatigue cracking and other structural issues due to repeated operation of the packer 707.

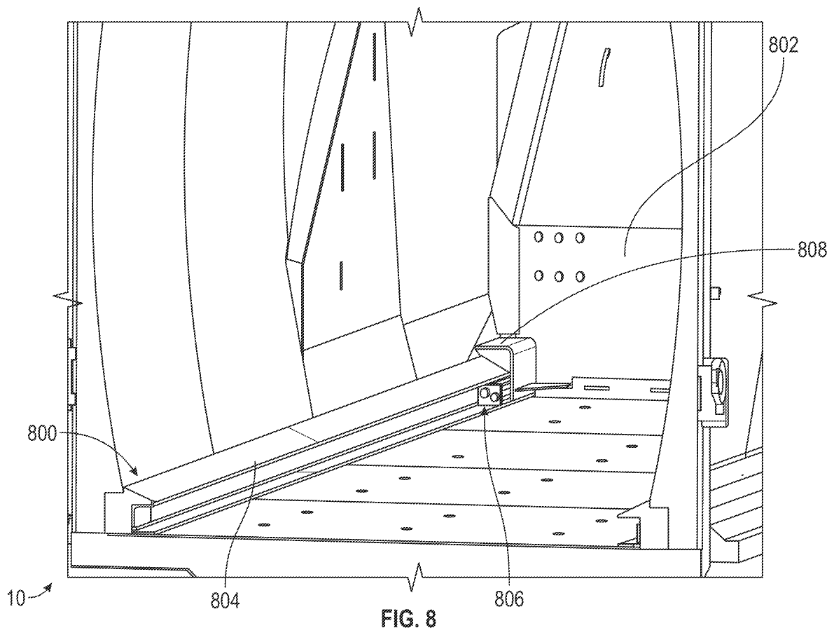

Referring to FIG. 8, an ejector mechanism 800 (e.g., an ejector assembly, etc.) of a refuse vehicle 10 (e.g., refuse container, etc.) is shown, according to an embodiment. The ejector mechanism 800 includes a refuse ejector 802 (e.g., an ejector, a combined packer/ejector plate, a pusher plate, etc.) that is configured to move along an ejector track 804. The ejector mechanism 800 also includes an ejector actuator 806 configured to power movement of the refuse ejector 802 along the ejector track 804. The ejector actuator 806 is communicatively coupled to a processing unit that is configured to provide signals to selectively actuate the ejector actuator 806. The ejector actuator 806 includes an ejector body 808 which is coupled to the refuse ejector 802. The ejector actuator 806 is nestably engaged with the ejector track 804 and moves along the ejector track 804 between a refuse receiving position (e.g., a first position, etc.) and a refuse ejecting position (e.g., a second position, etc.).

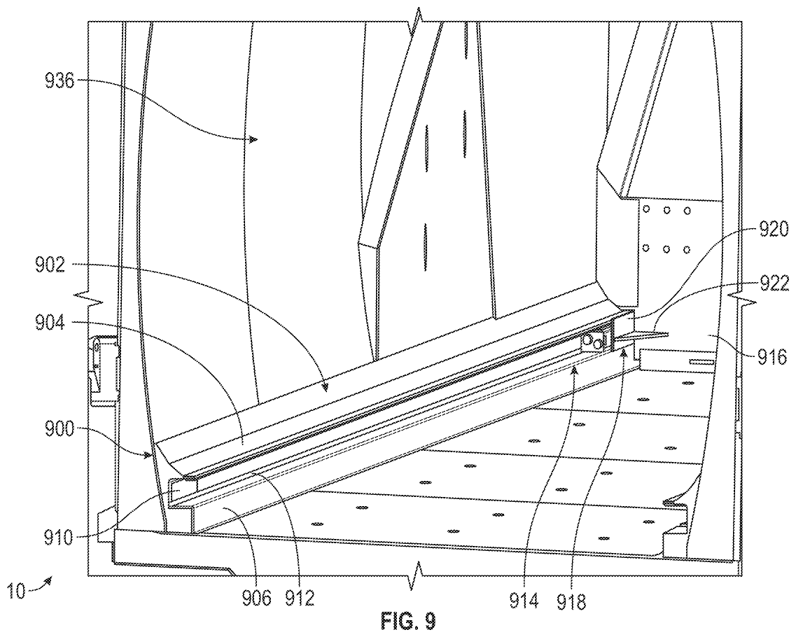

Referring to FIG. 9, another ejector mechanism 900 (e.g., an ejector assembly, etc.) that can be used with the refuse vehicle 10 is shown, according to an embodiment. The ejector mechanism 900 is designed to increase reliability during operation of ejecting refuse. The ejector mechanism 900 includes an ejector track 902, an ejector actuator 914, and a refuse ejector 916. Ejector tracks 902 are disposed along both lateral sides of the refuse container.

As shown in FIG. 9, the ejector track 902 is coupled to an inner portion of a container sidewall 936. In some embodiments the ejector track 902 is integrally formed with the container sidewall 936. The ejector track 902 extends along the longitudinal direction within the refuse container proximate to a bottom wall (e.g., a floor, a base wall, etc.) of the collection chamber. In some embodiments, the ejector track extends the length of the container sidewall 936. The ejector track 902 includes a top track portion 904 and a bottom track portion 906. The top track portion 904 is contiguous with the bottom track portion 906 via a connection wall 910 (e.g., an intermediate portion of the ejector track 902). The top track portion 904, the bottom track portion 906, and the connection wall 910 together define a rectangular-shaped channel 912. The channel 912 is spaced vertically apart from the bottom wall by the bottom track portion 906 so as to substantially prevent ingestion of liquid refuse into the ejector track. An upper surface of the top track portion 904 is angled and/or curved such that a height of the upper surface decreases moving laterally toward a distal end of the ejector track 902. A distal edge (e.g., a lower edge, etc.) of the packer plate may have a shape that corresponds with a shape of the upper surface of the top track portion 904 so that the packer plate nestably engages the upper surface, which can help clear the upper surface of refuse during packer operation.

The ejector track 902 may be formed from a metal (e.g., steel, aluminum, etc.) or another material. In some embodiments, the ejector track 902 may be formed from an alloy (e.g., stainless steel alloys, aluminum alloys, nickel alloys, etc.). In some embodiments, the ejector track 902 has a height within a range between approximately 1 inch (in.) to 12 in. (e.g., 1 in., 2 in., 3 in., 4 in., 5 in., 6 in., 7 in., 8 in., 9 in., 10 in., 11 in., 12 in., etc.). In some embodiments, a length of the ejector track 902 is within a range between approximately 130 in. to 180 in. (e.g., 130 in., 140 in., 150 in., 160 in., 170 in., 180 in., etc.). In other embodiments, the dimensions of the ejector track 902 may be different.

The ejector mechanism 900 includes an ejector actuator 914 configured to selectively move along the channel 912 of the ejector track 902. The ejector actuator 914 is positioned between the top track portion 904 and the bottom track portion 906 and is configured to actuate within the channel 912. For example, when the ejector actuator 914 is communicatively coupled to a processing unit shown as a processor 44. The processor 44 is configured to provide signals to selectively actuate an actuating arm of the ejector actuator 914 which extends from the ejector actuator 914 extends within the channel 912. In some embodiments, the ejector actuator 914 is an electrically-driven linear actuator. For example, in some embodiments, the ejector actuator 266 is one of a lead screw/lead nut type actuator, a lead screw/ball nut type actuator, a lead screw/roller nut type actuator, a linear motor, or any other suitable type of electrically-driven linear actuator. In some embodiments, the ejector actuator is a rack and pinion actuator or a hydraulic actuator.

The ejector mechanism 900 includes a refuse ejector 916 configured to compact refuse within the collection chamber (such as collection chamber 24 of FIG. 1) or eject the refuse from the collection chamber. The ejector mechanism 900 includes a mounting assembly 918. The mounting assembly 918 includes a mounting plate 920 and a mounting bracket 922 (e.g., flange, etc.). The mounting plate 920 is coupled to the ejector actuator 914. The mounting bracket 922 is coupled to the mounting plate 920 at along a first edge of the mounting bracket 922. In some embodiments the mounting bracket 922 and the mounting plate 920 are integrally formed. The mounting bracket 922 is coupled to the refuse ejector 916 at a second edge of the mounting bracket 922. By this way, the refuse ejector 916 is coupled to the ejector actuator 914. As the ejector actuator 914 is operated, the refuse ejector 916 is configured to move along the ejector track 902 between a receiving position and a packing position. For example, in the packing position, tailgate 40 is in the closed position and the refuse ejector 916 is moved along the ejector track 264 toward the tailgate 40, thereby compacting any refuse contained within the collection chamber 24. In the ejecting position, the tailgate 40 is in the opened position, and the refuse ejector 916 is moved along the ejector track 90 toward the tailgate 40, thereby ejecting any refuse contained within the collection chamber 24 out of a rear end of the refuse collection chamber 24.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the present disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

References herein to the positions of elements (e.g., “first”, “second”, “third”, etc.,) are used to distinguish one element from another element without necessarily requiring or implying any actual such relationship or order. It should be noted that the orientation of various elements may differ according to other exemplary embodiments, and that such variations are intended to be encompassed by the present disclosure.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle, comprising:
a chassis;
a body supported by the chassis and defining a collection chamber configured to store refuse therein, the body including a bottom wall and a sub-frame assembly, the sub-frame assembly including:
a pair of frame rails coupled to the bottom wall and extending in a longitudinal direction along the bottom wall; and
a plurality of cross-members engaged with the bottom wall, the plurality of cross-members extending in a lateral direction that is substantially perpendicular to the longitudinal direction, each of the plurality of cross-members extending through the pair of frame rails, the plurality of cross-members each having a uniform cross-sectional shape along their entire length.

2. The refuse vehicle of claim 1, wherein at least one of the plurality of cross-members at a single longitudinal position includes a pair of identical sections arranged in a diametrically opposed pair on either side of the pair of frame rails.

3. The refuse vehicle of claim 1, wherein each of the pair of frame rails comprises a beam defining a rectangular-shaped channel that extends in the longitudinal direction between opposing ends of the beam, the channel of each of the pair of frame rails facing inwardly toward a center of the body.

4. The refuse vehicle of claim 3, wherein the sub-frame assembly further includes at least one bracket configured to couple a respective one of the plurality of cross-members to at least one frame rail of the pair of frame rails, the bracket disposed within the channel of the at least one frame rail, the bracket engaged with a longitudinal face of the respective one of the plurality of cross-members.

5. The refuse vehicle of claim 1, wherein the pair of frame rails each include a plurality of slots extending from the bottom wall, the plurality of cross-members disposed in the plurality of slots.

6. The refuse vehicle of claim 1, further comprising:
an arm lug assembly configured to secure an actuator to the body, the arm lug assembly comprising:
a first plate including a first lug portion;
a second plate including a second lug portion, the second plate spaced laterally apart from the first plate;
a first coupling member coupled to a first cross-member of the plurality of cross-members at a first end and a second cross-member of the plurality of cross-members at a second end; and
a second coupling member coupled to the second cross-member on an opposite side of the second cross-member as the first coupling member.

7. The refuse vehicle of claim 6, wherein the second cross-member of the plurality of cross-members extends through the first plate and is coupled to the second plate.

8. The refuse vehicle of claim 6, wherein the first coupling member and the second coupling member together define a ‘V’ shape.

9. The refuse vehicle of claim 1, further comprising an arm lug assembly configured to secure an actuator to the body, the body further comprising a container sidewall extending along a lateral edge of the bottom wall, the container sidewall including:
a plurality of vertical beams spaced apart along the longitudinal direction; and
a support beam that extends at an angle between a longitudinal end of the container sidewall and the arm lug assembly.

10. A refuse vehicle, comprising:
a chassis;
a body supported by the chassis and defining a collection chamber configured to store refuse therein; and
an arm lug assembly configured to secure an actuator to the body, the arm lug assembly comprising:
a first plate including a first lug portion;
a second plate including a second lug portion, the second plate spaced laterally apart from the first plate;
a cross-member extending through the first plate to the second plate;
a first coupling member coupled to the first plate and the cross-member and extending at a first angle away from the cross-member; and
a second coupling member coupled to the cross-member opposite the first coupling member, the second coupling member arranged symmetrically with the first coupling member.

11. The refuse vehicle of claim 10, wherein the first lug portion and the second lug portion each define an opening configured to receive a pivot pin therein to pivotally couple the actuator to the first plate and the second plate.

12. The refuse vehicle of claim 10, wherein the first coupling member and the second coupling member together define a ‘V’ shape.

13. The refuse vehicle of claim 10, wherein the first coupling member is angled along (i) a first angle of inclination directed laterally away from a longitudinal axis of the body, and (ii) a second angle of inclination directed axially away from the body.

14. The refuse vehicle of claim 10, wherein the first coupling member is coupled to a portion of the first plate that extends substantially parallel to the first coupling member.

15. The refuse vehicle of claim 10, wherein a distal end of at least one of the first plate or the second plate define an arcuate edge having a first convex portion, a second convex portion, and a concave portion extending from the first convex portion to the second convex portion.

16. The refuse vehicle of claim 10, wherein the body further comprises a bottom wall and a container sidewall extending along a lateral edge of the bottom wall, the container sidewall including:
a plurality of vertical beams spaced apart along a longitudinal direction; and
a support beam that extends at an angle between a longitudinal end of the container sidewall and the arm lug assembly.

17. A refuse vehicle, comprising:
a chassis;
a body supported by the chassis and defining a collection chamber configured to store refuse therein, the body including a bottom wall and a container sidewall extending along a lateral edge of the bottom wall; and
an arm lug assembly configured to secure an actuator to the body, the container sidewall including:
a plurality of vertical beams spaced apart along a longitudinal direction; and
a support beam that extends at an angle between a longitudinal end of the container sidewall and the arm lug assembly.

18. The refuse vehicle of claim 17, the refuse vehicle further comprising a packer actuator coupled to the body, the support beam substantially aligned with a force vector caused by packing forces applied to the body during operation of the packer actuator.

19. The refuse vehicle of claim 17, wherein the angle is taken relative to a longitudinal reference line extending through the body between opposing ends of the body.

20. The refuse vehicle of claim 17, wherein the support beam is coupled to an end of the plurality of vertical beams.
